(19) United States
(12) Patent Application Publication
(10) Pub. No.: US 2024/0164380 A1
(43) Pub. Date: May 23, 2024

(54) ANTIFUNGAL COMPOSITIONS AND METHODS FOR THEIR USE

(71) Applicant: Texas Crop Science, Inc., Austin, TX (US)

(72) Inventors: Simon Hiebert, Austin, TX (US); Jeffrey D. Fowler, Austin, TX (US)

(21) Appl. No.: 18/384,286

(22) Filed: Oct. 26, 2023

Related U.S. Application Data
(60) Provisional application No. 63/419,568, filed on Oct. 26, 2022.

(51) Int. Cl. A01N 43/54; A01N 33/26; A01P 3/00

(52) U.S. Cl. CPC A01N 43/54; A01N 33/26; A01P 3/00

(57) ABSTRACT

The present disclosure provides antifungal compositions and methods for their use. In particular, the compositions comprise (E)-3-methyl-N′-(1-(naphthalen-2-yl) ethylidene)benzohydrazide, which enhances or potentiates the activity of certain fungicides.

### CROSS REFERENCE TO RELATED APPLICATION

This application claims the benefit of the earlier filing date of U.S. provisional patent application No. 63/419,568, filed Oct. 26, 2022, which is incorporated herein by reference in its entirety.

### FIELD

The present disclosure relates to compositions and methods for the treatment of crops susceptible to fungal pathogens.

### BACKGROUND

Crops are plagued worldwide by fungal pathogens. Fungi have developed an array of mechanisms for surviving fungicides, such as by sequestering, exporting or detoxifying them. There is a need for formulations to potentiate the efficacy of fungicides by blocking certain mechanisms of resistance.

### SUMMARY

Disclosed herein are methods and compositions for use in supporting crop viability and yield, by, for example, protecting crops from fungal pathogens. In one embodiment, disclosed herein is a method for potentiating the efficacy of a fungicide by treating a crop with an apyrase inhibitor having the formula of Compound 1:

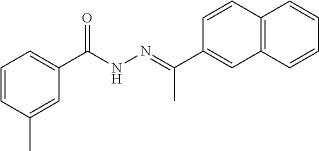 [SMILES: C/C(=N\NC(=O)c1cccc(C)c1)c1ccc2ccccc2c1]

(E)-3-methyl-N′-(1-(naphthalen-2-yl)ethylidene)benzohydrazide. in combination with a particular fungicide. In one embodiment, treatment of the crop with the apyrase inhibitor is synergistic with the fungicide.

The foregoing and other objects, features, and advantages of the invention will become more apparent from the following detailed description, which proceeds with reference to the accompanying figures.

### BRIEF DESCRIPTION OF THE FIGURES

FIG. 1 illustrates Asian soybean rust severity in untreated crop (UTC) versus soy treated with azoxystrobin, chlorothalonil, tebuconazole or azoxystrobin and tebuconazole with and without the present enhancer compound (TX 15) at 1, 7, 9, 14 and 16 days after application (DAA).

FIG. 2 illustrates frogeye leaf spot intensity of infection in soy in untreated crop (UTC) versus soy treated with azoxystrobin, chlorothalonil, tebuconazole or azoxystrobin and tebuconazole with and without the present enhancer compound (TX15) at 4, 11 and 18 (two trials) days after application (DAA).

FIG. 3 illustrates yellow rust foliar infection percentage of wheat in untreated crop (UTC) versus wheat with preventive application of AMISTAR® (azoxystrobin), folpet, PROLINE® (prothioconazole), REVYSTAR® (fluxapyroxad and mefentrifluconazole), A20944 (prothioconazole and pydiflumetofen), ELATUS® ERA (prothioconazole and benzovindiflupyr), A21857 (ADEPIDYN®; pydiflumetofen), INATREQ® (fenpicoxamid) with and without the present enhancer compound (TX 15).

FIG. 4 illustrates a time course of yellow rust foliar infection percentage of wheat in untreated crop versus wheat with preventive application of prothioconazole or prothioconazole in combination with the present enhancer compound (TX 15).

FIG. 5 illustrates Septoria foliar infection percentage of wheat in untreated crop (UTC) versus wheat with preventive application of AMISTAR® (azoxystrobin), folpet, PROLINE® (prothioconazole), REVYSTAR® (fluxapyroxad and mefentrifluconazole), A20944 (prothioconazole and pydiflumetofen), ELATUS® ERA (prothioconazole and benzovindiflupyr), A21857 (ADEPIDYN®; pydiflumetofen), INATREQ® (fenpicoxamid) with and without the present enhancer compound (TX 15).

FIG. 6 illustrates Septoria foliar infection percentage of wheat in four winter wheat crops treated with standard fungicide versus treatment with standard fungicide and the present enhancer compound (TX 15).

FIG. 7 illustrates the severity of downy mildew attack on grape crops assessed as to bunches and leaves in untreated crop (UTC) versus crop treated with cyazofamid or cyazofamid and the present enhancer compound (TX 15).

FIG. 8 illustrates the percentage infection of grape crop that are untreated (UTC) versus grape crop treated with QUADRIS TOP® (azoxystrobin and difenoconazole) alone or in combination with the present enhancer compound (TX 15).

FIG. 9 illustrates the percentage infection of winter wheat with Zymoseptoria tritici following treatment with metconazole and with metconazole in combination with the present enhancer compound (TX 15) versus untreated crop.

### DETAILED DESCRIPTION

### I. Terms

The following explanations of terms and methods are provided to better describe the present disclosure and to guide those of ordinary skill in the art in the practice of the present disclosure. The singular forms “a,” “an,” and “the” refer to one or more than one, unless the context clearly dictates otherwise. The term “or” refers to a single element of stated alternative elements or a combination of two or more elements, unless the context clearly indicates otherwise. As used herein, “comprises” means “includes.” Thus, “comprising A or B,” means “including A, B, or A and B,” without excluding additional elements. All references, including patents and patent applications cited herein, are incorporated by reference in their entirety, unless otherwise specified.

Unless otherwise indicated, all numbers expressing quantities of components, molecular weights, percentages, temperatures, times, and so forth, as used in the specification or claims, are to be understood as being modified by the term “about.” Accordingly, unless otherwise indicated, implicitly or explicitly, the numerical parameters set forth are approximations that may depend on the desired properties sought and/or limits of detection under standard test conditions/methods. When directly and explicitly distinguishing embodiments from discussed prior art, the embodiment numbers are not approximates unless the word “about” is expressly recited.

Unless explained otherwise, all technical and scientific terms used herein have the same meaning as commonly understood by one of ordinary skill in the art to which this disclosure pertains. Although methods and materials similar or equivalent to those described herein can be used in the practice or testing of the present disclosure, suitable methods and materials are described below. The materials, methods, and examples are illustrative only and not intended to be limiting.

“Administering” refers to any suitable mode of administration, to control a pathogen, such as a fungal pathogen, including, treatment of an extant crop, agricultural produce, seeds, soil or combination thereof. It is intended that as used herein, administering to a crop may refer to administering to benefit a crop by treating an extant crop, agricultural produce, seeds, soil or combination thereof.

“In combination with” refers to the administration of compounds either simultaneously in a single administration, or sequentially in two or more different administrations, that may be separated either in time, location, or method.

“Control” with reference to a fungal pathogen, means block, inhibit and/or eradicate the pathogen and/or prevent the pathogen from damaging a crop. In one embodiment, control refers to the reduction of one or more fungi to undetectable levels, or to the reduction or suppression of a fungal pathogen to acceptable levels as determined by one of ordinary skill in the art (for example, a crop grower). Determinations of acceptable levels of fungal pathogen reduction are based on a number of factors, including to the crop, pathogen, severity of the pathogen, use restrictions, economic thresholds and other factors known to those of ordinary skill in the art.

As used herein, the terms “enhancer” and “potentiator”, refer to a compound or compounds disclosed herein that enhance the effects of a fungicide. Without limitation to theory the present enhancer compound disclosed herein may function by blocking one or more pathways by which a fungal pathogen evades toxicity, such as by detoxifying, sequestering or transporting a fungicide. In certain embodiments, the present enhancer compound inhibits enzymatic apyrase activity which leads to the enhancement, accentuation or potentiation of a fungicide. For example, when the enhancer or potentiator is used in conjunction with a fungicide, the combination of the enhancer and the fungicide enhances the fungicidal effect of the fungicide and/or renders a fungus that has become resistant to the fungicide susceptible to the fungicide as a result of the activity of the enhancer. Most often, the present enhancer compound does not itself directly inhibit the growth of a fungus, nor does it have a detrimental effect on a crop that is (or could be) infected with a pathogen.

As used herein, the term “phytologically acceptable” refers to compositions, diluents, excipients, and/or carriers that are generally applicable for use with any part of a plant during any part of its life cycle, including but not limited to seeds, seedlings, plant cells, plants, or flowers. The compositions can be prepared according to procedures, methods and formulas that are known to those of skill in the agricultural arts. Following the teachings of the present disclosure the artist skilled in the agricultural and/or chemical arts can readily prepare a desired composition. Most commonly, the compounds of the present invention can be formulated to be stored, and/or applied, as aqueous or non-aqueous suspensions or emulsions prepared neat or from concentrated formulations of the compositions. Alternatively the compounds of the present invention can be formulated for use in aerosol-generating equipment for application to agricultural produce stored in sealed chambers—an application method known as fogging. Water-soluble, water-suspendable or emulsifiable formulations comprising the presently disclosed compounds can also be converted into or formulated as solids (for example, wettable powders), which can then be diluted into a final formulation. In certain formulations, the compositions of the present disclosure can also be provided in growth media, such as in vitro media for growth of plant or other types of cells, in laboratory plant growth media, in soil, or for spraying on seeds, seedlings, roots, stems, stalks, leaves, flowers or the entire plant.

As used herein, the term “treatment” refers to a method used to administer or apply an effective amount of a disclosed compound or formulation thereof to a target area of a field and/or plant. The treatment method can be, but is not limited to, aerosol spray, pressure spray, direct watering, chemigation, fogging, and dipping. Target areas of a plant could include, but are not limited to, the leaves, roots, stems, buds, flowers, fruit, seed of the plant, and bulbs of the plant including bulb, corm, rhizoma, stem tuber, root tuber and rhizophore. Treatment can include a method wherein a plant is treated in one area (for example, the root zone or foliage) and another area of the plant becomes protected (for example, foliage is treatment when a disclosed compound is applied in the root zone or new growth when applied to foliage).

### II. Enhancer Compound

Described herein are compositions comprising an enhancer compound having a structure

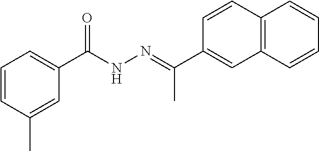 [SMILES: C/C(=N\NC(=O)c1cccc(C)c1)c1ccc2ccccc2c1]

(E)-3-methyl-N′-(1-(naphthalen-2-yl)ethylidene)benzohydrazide (also referred to herein as Compound 1). The compound is referred to herein by its chemical structure and name, however, as will be apparent to those of ordinary skill in the art upon consideration of the structure of the enhancer compound, the compound also may as its Z isomer. Also readily apparent to those of skill in the art will be the existence of tautomers of the illustrated enhancer compound. All such isomers and tautomers of the enhancer compound are intended herein.

The compound is referred to herein by its effect as an enhancer, potentiator or apyrase inhibitor. As is understood by those of ordinary skill in the art, the terms enhancer compound, potentiator compound and apyrase inhibitor all refer to (E)-3-methyl-N′-(1-(naphthalen-2-yl)ethylidene)benzohydrazide, its (Z)-isomer and tautomers thereof.

Without limitation to any particular theory, it is believed that the enhancer compound functions by blocking one or more pathways by which a fungal pathogen evades toxicity, such as by detoxifying, sequestering or transporting a fungicide. In one aspect, the present compound inhibits enzymatic apyrase activity which leads to the enhancement, accentuation or potentiation of a fungicide. For example, when the enhancer or potentiator is used in conjunction with a fungicide, the combination of the potentiator and the fungicide enhances the fungicidal effect of the fungicide and/or renders a fungus that has become resistant to the fungicide susceptible to the fungicide as a result of the activity of the potentiator. Most often, the present enhancer does not itself directly inhibit the fungus, nor does it have a detrimental effect on a seed, crop or crop product that is (or could be) infected with a fungus.

### III. Combination Treatment

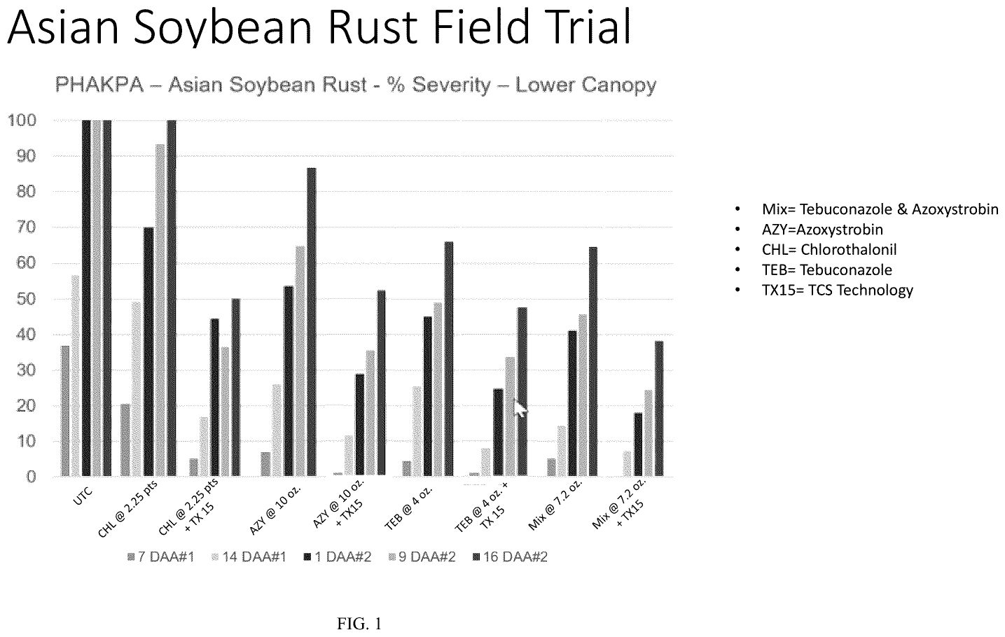

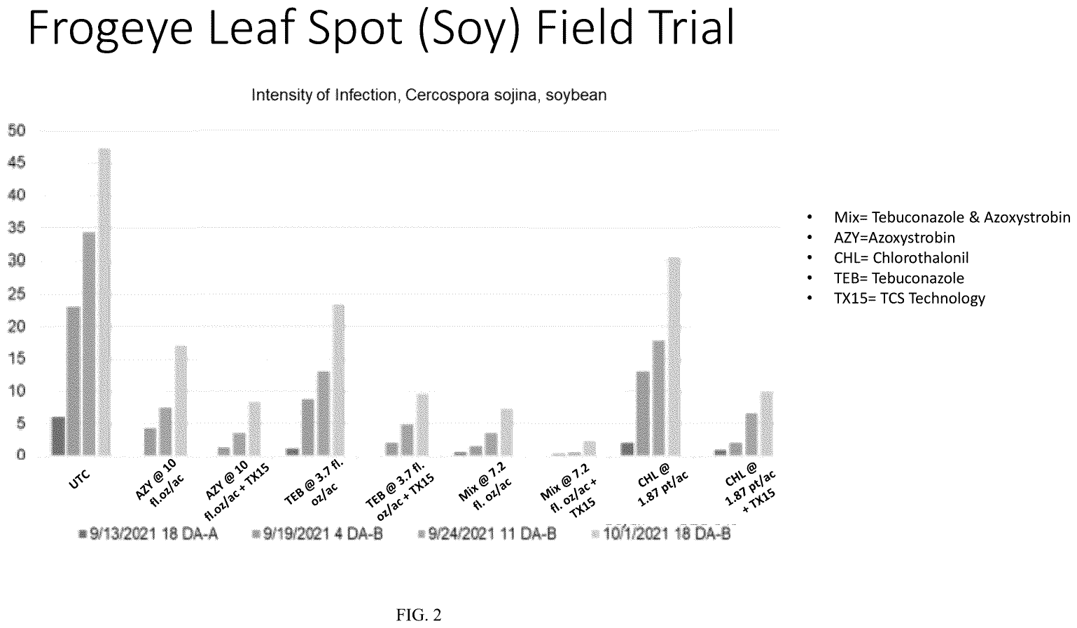

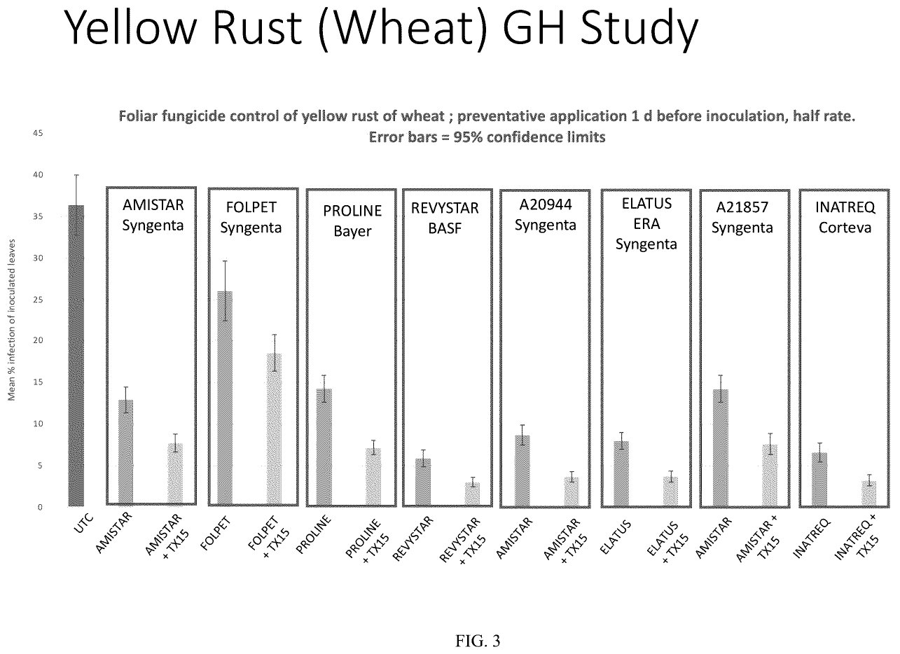

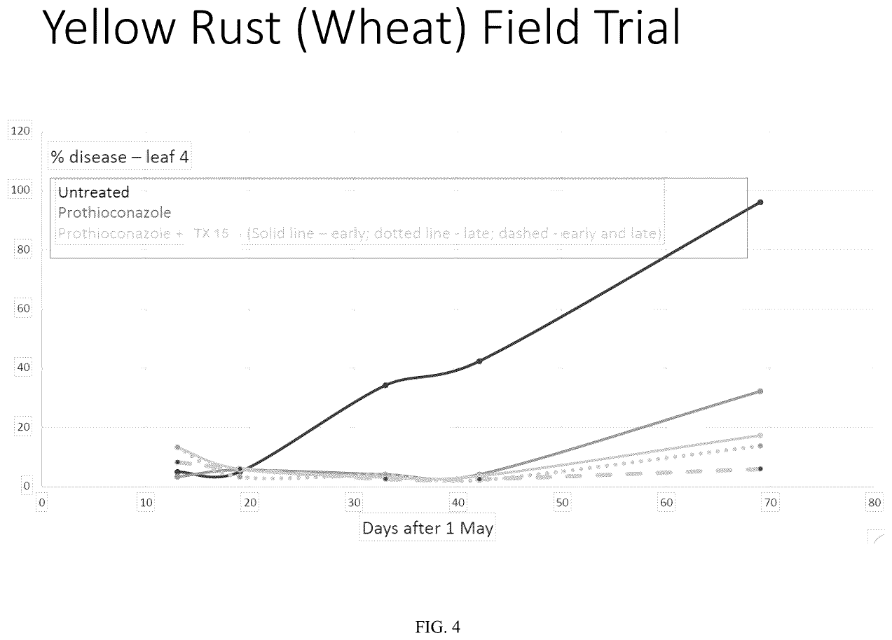

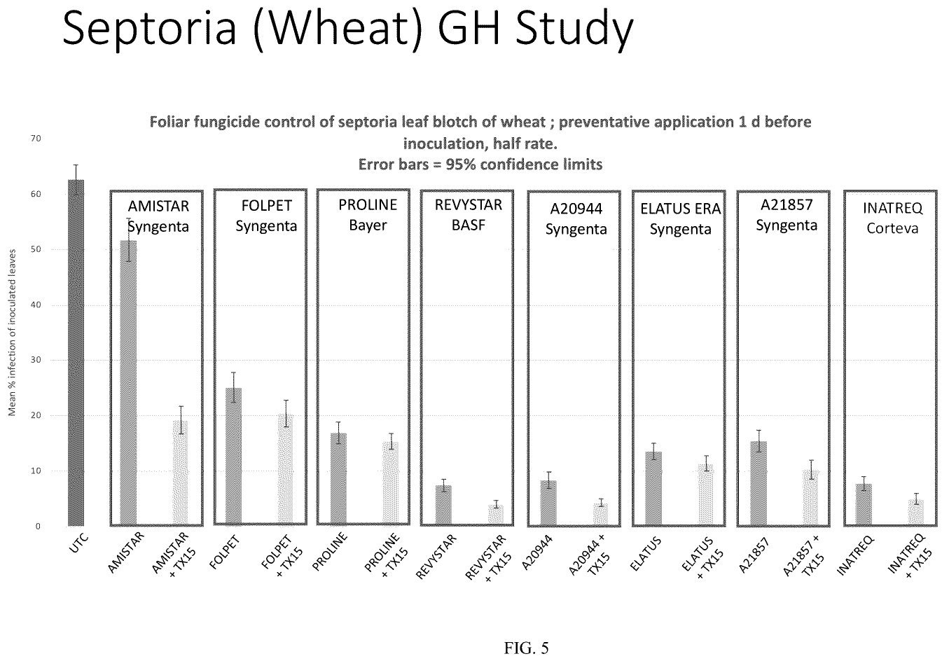

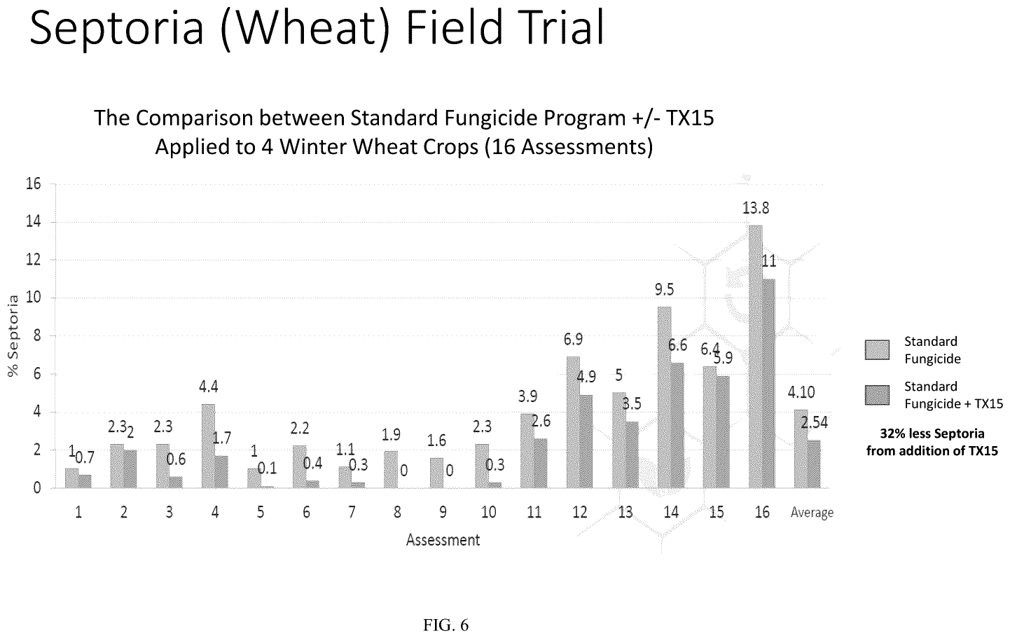

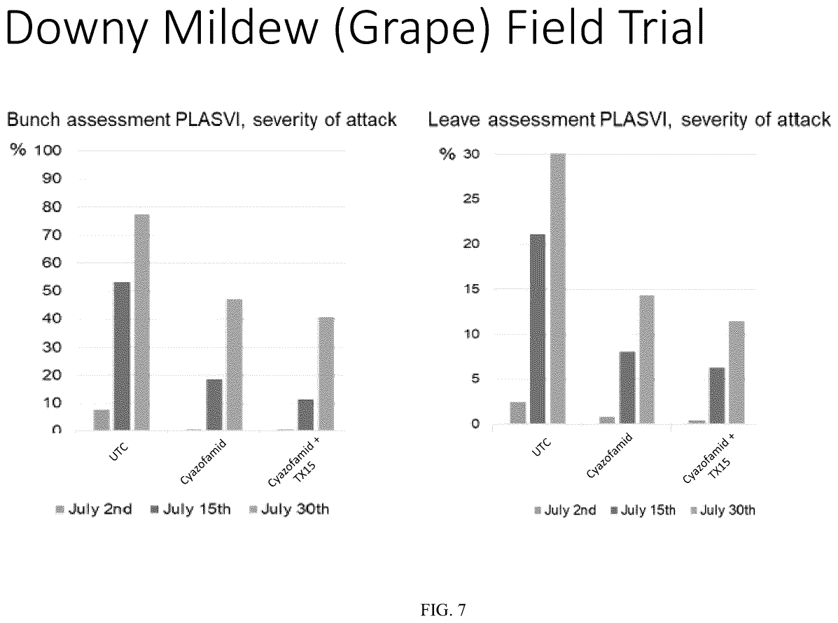

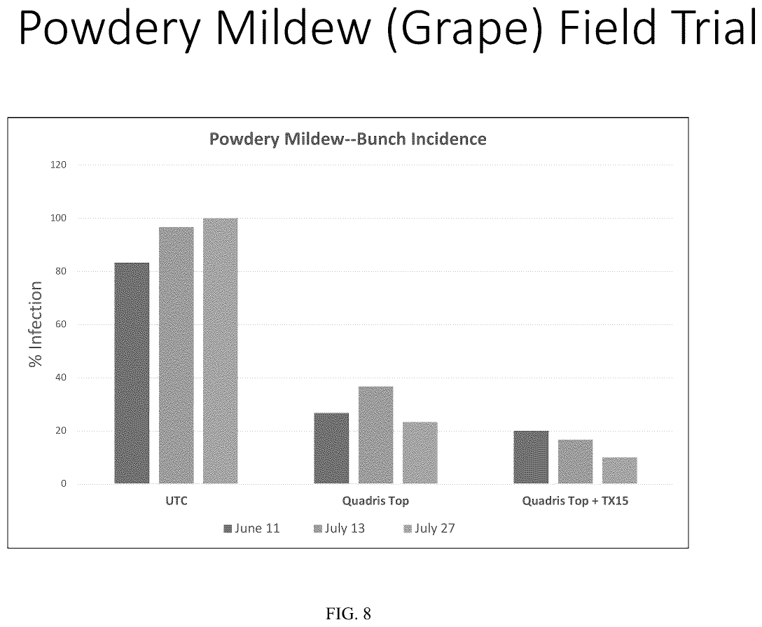

In one embodiment, the presently disclosed apyrase inhibitor is useful for enhancing the fungicidal effect of a variety of fungicides. The present inventors have found that particular fungicides are potentiated by the enhancer compound, whereas others are not. Thus, the fungicide for use in combination with the particular enhancer compound described herein must be carefully selected. In one embodiment, the combined treatment with a selected fungicide and the enhancer compound provides synergistic fungicidal activity against plant pathogenic fungi. As demonstrated by FIGS. 1-8 the present enhancer compound dramatically reduces fungal growth in combination with exemplary fungicides. In certain examples, the present enhancer compound differentially enhances the efficacy of certain fungicides. Certain fungicides are not potentiated by the present enhancer compound.

Fungicides that have their efficacy restored or enhanced by the present enhancer compound according to the present methods and compositions include azoxystrobin, difenoconazole, chlorothalonil, tebuconazole, folpet, prothioconazole, fluxapyroxad, metconazole, mefentrifluconazole, pydiflumetofen, benzovindiflupyr, fenpicoxamid, cyazofamid, pyraclostrobin, and combinations thereof.

In one embodiment, disclosed is a method for inhibiting fungal infection in a seed or plant at risk thereof, comprising contacting the seed or plant with a fungicide selected from the group consisting of azoxystrobin, difenoconazole, chlorothalonil, tebuconazole, folpet, prothioconazole, fluxapyroxad, metconazole, mefentrifluconazole, pydiflumetofen, benzovindiflupyr, fenpicoxamid, cyazofamid, pyraclostrobin, or a combination thereof.

In one embodiment, the fungicide potentiated by the present enhancer compound comprises fenpicoxamid.

In one embodiment the fungicide potentiated by the present enhancer compound comprises pydiflumetofen. In one such embodiment, the fungicide comprises prothioconazole in addition to pydiflumetofen.

In one embodiment, a fungicide potentiated by the present enhancer compound comprises benzovindiflupyr. In one such embodiment, the fungicide comprises prothioconazole in addition to benzovindiflupyr.

In one embodiment, the fungicide potentiated by the present enhancer compound comprises fluxapyroxad. In one embodiment, the fungicide potentiated by the present enhancer compound comprises mefentrifluconazole. In one embodiment, the fungicide potentiated by the present enhancer compound comprises fluxapyroxad and mefentrifluconazole.

In one embodiment, the fungicide potentiated by the present enhancer compound comprises a strobilurin, such as azoxystrobin, pyraclostrobin, or both. In one embodiment, the fungicide potentiated by the present enhancer compound comprises a fungicide that is selected from azoxystrobin, pyraclostrobin or a combination thereof. In one embodiment, the fungicide potentiated by the present enhancer compound comprises azoxystrobin. In one embodiment, the fungicide potentiated by the present enhancer compound comprises pyraclostrobin, and in one such embodiment the fungicide comprises pyraclostrobin and mefentrifluconazole.

In one embodiment, the fungicide potentiated by the present enhancer compound comprises azoxystrobin, fluxapyroxad, pydiflumetofen, or a combination thereof. In one embodiment, the fungicide potentiated by the present enhancer compound comprises azoxystrobin, pydiflumetofen, or both. In one embodiment, the fungicide potentiated by the present enhancer compound comprises azoxystrobin and pydiflumetofen.

In one embodiment, the fungicide potentiated by the present enhancer compound comprises difenoconazole, mefentrifluconazole, prothioconazole or both. In one embodiment, the fungicide potentiated by the present enhancer compound comprises mefentrifluconazole, prothioconazole or both. In one embodiment a fungicide potentiated by the present enhancer compound is mefentrifluconazole. In one embodiment a fungicide potentiated by the present enhancer compound is prothioconazole. In one embodiment a fungicide potentiated by the present enhancer compound is difenoconazole.

In one embodiment, the fungicide potentiated by the present enhancer compound comprises fluxapyroxad. In one embodiment, the fungicide potentiated by the present enhancer compound comprises mefentrifluconazole and fluxapyroxad.

In one embodiment, the fungicide potentiated by the present enhancer compound comprises folpet.

In one embodiment, the fungicide potentiated by the present enhancer compound comprises a triazole carboxamide, such as ethaboxam.

In one embodiment, the disclosure provides compositions and methods of treating plants or plant seeds infected with or at risk of being infected with a fungal pathogen. In one embodiment compositions of the present disclosure comprise a fungicide, such as one or more fungicide described above, the enhancer compound, and a phytologically acceptable carrier. In another embodiment, the fungicide and enhancer compound are administered in separate compositions.

In further embodiments, an agricultural or horticultural fungicide is used in combination with other compounds in addition to the disclosed enhancer compound. Such other compounds can be administered in the same or separate compositions as the fungicide and/or formulation. Examples of the other components include known carriers to be used to conduct formulation. Additional examples thereof include conventionally-known herbicides, insecticidal/acaricidal agents, nematodes, molluscicides, soil pesticides, plant control agents, synergistic agents, fertilizers and soil conditioners. In one embodiment, the inclusion of such other components yields further enhancements on crop growth, and in some embodiments yield synergistic effects on crop growth.

### IV. Target Crops and Their Pathogens

The present disclosure provides formulations and methods for their use in treating crops, produce, seeds and soil for fungal pathogens. In one embodiment, the present enhancer compound, is administered in combination with an agricultural or fungicide, such as a fungicide described above in Section III. Crops that can be treated, include those plagued by fungal pathogens, as is known to those of ordinary skill in the agricultural arts. By way of example, such agricultural and horticultural crops that can be treated according to the present disclosure include plants, whether genetically modified or not, including their harvested products, such as: cereals; vegetables; root crops; potatoes; trees such as fruit trees, for example banana trees, tea, coffee trees, or cocoa trees; grasses; lawn grass; or cotton.

The agricultural or horticultural enhancer and fungicide combinations disclosed herein may be applied to each part of plants, such as leaves, stems, patterns, flowers, buds, fruits, seeds, sprouts, roots, tubers, tuberous roots, shoots, or cuttings. The agricultural or horticultural enhancer according to the present disclosure may also be applied to improved varieties/varieties, cultivars, as well as mutants, hybrids and genetically modified embodiments of these plants.

The agricultural or horticultural treatment described herein may be used to conduct seed treatment, foliage application, soil application, or water application, so as to control various diseases occurring in agricultural or horticultural crops, including flowers, lawns, and pastures.

The present enhancer compound is particularly useful for potentiating the effects of fungicides against plant fungal pathogens. Examples of pathogens treated according to the present methods and compositions include, without limitation, Botrytis cinerea, Colletotrichum graminicola, Fusarium oxysporum, Sclerotiana sclerotiorum, Verticillium dahlia, Mycospharella gramincola and Sphacelotheca reliana.

Botrytis cinerea is an airborne plant pathogen with a necrotrophic lifestyle attacking over 200 crop hosts worldwide. It mainly attacks dicotyledonous plant species, including important protein, oil, fiber and horticultural crops, grapes and strawberries and also Botrytis also causes secondary soft rot of fruits and vegetables during storage, transit and at the market. Many classes of fungicides have failed to control Botrytis cinerea due to its genetic plasticity.

The genus Colletotrichum comprises ˜600 species attacking over 3,200 species of monocot and dicot plants. Colletotrichum graminicola primarily infects maize (Zea mays), causing annual losses of approximately 1 billion dollars in the United States alone (Connell et al., 2012).

Another pathogen that can be treated according to the present methods and compositions is fusarium wilt of banana, caused by the soil-borne fungus Fusarium oxysporum f.sp. cubense, is a major threat to banana production worldwide. No fungicides are currently available to effectively control the disease once plants are infected (Peng J et al., 2014).

The white mold fungus Sclerotinia sclerotiorum is known to attack more than 400 host species and is considered one of the most prolific plant pathogens. Sclerotinia sclerotiorum is another pathogen that can be treated according to the present methods and compositions to improve crop health and yield. The majority of the affected crop species are dicotyledonous, along with a number of agriculturally significant monocotyledonous plants. Some important crops affected by S. sclerotiorum include legumes (soybean), most vegetables, stone fruits and tobacco.

The ascomycete Verticillium dahliae is a soil-borne fungal plant pathogen that causes vascular wilt diseases in a broad range of dicotyledonous host species. V. dahliae can cause severe yield and quality losses in cotton and other important crops such as vegetables, fibers, fruit, nut trees, forest trees and ornamental plants.

The ascomycete fungus Mycospharella gramincola (anamorph: Septoria tritici) is one of the most important foliar diseases of wheat leaves, occurring wherever wheat is grown. Yield losses attributed to this disease range from 25%-50%, and are especially high in Europe, the Mediterranean region and East Africa. Infection by M. gramincola is initiated by air borne ascopores produced on residues of last season's crop. Primary infection usually occurs after seedlings emerge in spring or fall. The mature disease is characterized by necrotic lesions on the leaves and stems of infected plants.

The basidiomycete fungus Sphacelotheca reliana infects corn (Zea mays) systemically, causing Head Smut. Yield loss attributed to the disease is variable, and is directly dependent on the incidence of the disease. The fungus overwinters as diploid teliospores in crop debris or soil. Floral structures are converted to sori containing masses of powdery teliospores that resemble mature galls of common smut.

Examples of crops to be treated and plant diseases (pathogens) to be controlled using the presently disclosed methods and compositions include, without limitation:

Sugar beet: brown spot disease (Cercospora beticola), black root disease (Aphanomyces cochlioides), root rot disease (Thanatephorus cucumeris), leaf rot disease (Thanatephorus cucumeris), and the like.

Peanut: brown spot disease (Mycosphaerella arachidis), leaf mold (Ascochyta sp.), rust disease (Puccinia arachidis), damping-off disease (Pythium debaryanum), rust spot disease (Alternaria alternata), stem rot disease (Sclerotium rolfsii), black rust disease (Mycosphaerella berkeleyi), and the like.

Cucumber: powdery mildew (Sphaerotheca fuliginea), downy mildew (Pseudoperonospora cubensis), gummy stem blight (Mycosphaerella melonis), wilt disease (Fusarium oxysporum), sclerotinia rot (Sclerotinia sclerotiorum), gray mold (Botrytis cinerea), anthracnose (Colletotrichum orbiculare), scab (Cladosporium cucumerinum), brown spot disease (Corynespora cassiicola), damping-off disease (Pythium debaryanum, Rhizoctonia solani Kuhn), Phomopsis root rot disease (Phomopsis sp.), Bacterial spot (Pseudomonas syringae pv. Lechrymans), and the like.

Tomato: gray mold disease (Botrytis cinerea), leaf mold disease (Cladosporium falvum), late blight disease (Phytophthora infestans), Verticillium wilt disease (Verticillium albo-atrum, Verticillium dahliae), powdery mildew disease (Oidium neolycopersici), early blight disease (Alternaria solani), leaf mold disease (Pseudocercospora fuligena), and the like.

Eggplant: gray mold disease (Botrytis cinerea), black rot disease (Corynespora melongenae), powdery mildew disease (Erysiphe cichoracearum), leaf mold disease (Mycovellosiella nattrassii), Sclerotinia rot disease (Sclerotinia sclerotiorum), Verticillium wilt disease (Verticillium dahlia), Mycosphaerella blight (Phomopsis vexans), and the like.

Strawberry: gray mold disease (Botrytis cinerea), powdery mildew disease (Sphaerotheca humuli), anthracnose disease (Colletotrichum acutatum, Colletotrichum fragariae), Phytophthora rot disease (Phytophthora cactorum), soft rot disease (Rhizopus stolonifer), Fusarium wilt disease (Fusarium oxysporum), Verticillium wilt disease (Verticillium dahlia), and the like.

Onion: neck rot disease (Botrytis allii), gray mold disease (Botrytis cinerea), leaf blight disease (Botrytis squamosa), downy mildew disease (Peronospora destructor), Phytophthora porn disease (Phytophthora porn), and the like.

Cabbage: clubroot disease (Plasmodiophora brassicae), soft rot disease (Erwinia carotovora), black rot disease (Xanthomonas campesrtis pv. campestris), bacterial black spot disease (Pseudomonas syringae pv. Maculicola, P.s. pv. alisalensis), downy mildew disease (Peronospora parasitica), Sclerotinia rot disease (Sclerotinia sclerotiorum), black spot disease (Alternaria brassicicola), gray mold disease (Botrytis cinerea), and the like.

Common bean: Sclerotinia rot disease (Sclerotinia sclerotiorum), gray mold disease (Botrytis cinerea), anthracnose (Colletotrichum lindemuthianum), angular spot disease (Phaeoisariopsis griseola), and the like.

Apple: powdery mildew disease (Podosphaera leucotricha), scab disease (Venturia inaequalis), Monilinia disease (Monilinia mall), black spot disease (Mycosphaerella pomi), valla canker disease (Valsa mali), alternaria blotch disease (Alternaria mali), rust disease (Gymnosporangium yamadae), ring rot disease (Botryosphaeria berengeriana), anthracnose disease (Glomerella cingulata, Colletotrichum acutatum), leaf rot disease (Diplocarpon mali), fly speck disease (Zygophiala jamaicensis), Sooty blotch (Gloeodes pomigena), violet root rot disease (Helicobasidium mompa), gray mold disease (Botrytis cinerea), and the like.

Japanese apricot: scab disease (Cladosporium carpophilum), gray mold disease (Botrytis cinerea), brown rot disease (Monilinia mumecola), and the like.

Persimmon: powdery mildew disease (Phyllactinia kakicola), anthracnose disease (Gloeosporium kaki), angular leaf spot (Cercospora kaki), and the like.

Peach: brown rot disease (Monilinia fructicola), scab disease (Cladosporium carpophilum), phomopsis rot disease (Phomopsis sp.), bacterial shot hole disease (Xanthomonas campestris pv. pruni), and the like.

Almond: brown rot disease (Monilinia taxa), spot blotch disease (Stigmina carpophila), scab disease (Cladosporium carpophilum), red leaf spot disease (Polystigma rubrum), Alternaria blotch disease (Alternaria alternata), anthracnose (Colletotrichum gloeospoides), and the like.

Yellow peach: brown rot disease (Monilinia fructicola), anthracnose disease (Colletotrichum acutatum), black spot disease (Alternaria sp.), Monilinia kusanoi disease (Monilinia kusanoi), and the like.

Grape: gray mold disease (Botrytis cinerea), powdery mildew disease (Uncinula necator), ripe rot disease (Glomerella cingulata, Colletotrichum acutatum), downy mildew disease (Plasmopara viticola), anthracnose disease (Elsinoe ampelina), brown spot disease (Pseudocercospora vitis), black rot disease (Guignardia bidwellii), white rot disease (Coniella castaneicola), rust disease (Phakopsora ampelopsidis), and the like.

Pear: scab disease (Venturia nashicola), rust disease (Gymnosporangium asiaticum), black spot disease (Alternaria kikuchiana), ring rot disease (Botryosphaeria berengeriana), powdery mildew disease (Phyllactinia mall), Cytospora canker disease (Phomopsis fukushii), brown spot blotch disease (Stemphylium vesicarium), anthracnose disease (Glomerella cingulata), and the like.

Tea: ring spot disease (Pestalotiopsis longiseta, P. theae), anthracnose disease (Colletotrichum theae-sinensis), Net blister blight (Exobasidium reticulatum), and the like.

Citrus fruits: scab disease (Elsinoe fawcettii), blue mold disease (Penicillium italicum), common green mold disease (Penicillium digitatum), gray mold disease (Botrytis cinerea), melanose disease (Diaporthe citri), canker disease (Xanthomonas campestris pv. Citri), powdery mildew disease (Oidium sp.), and the like.

Wheat: powdery mildew (Blumeria graminis f. sp. tritici), red mold disease (Gibberella zeae), red rust disease (Puccinia recondita), brown snow mold disease (Pythium iwayamai), pink snow mold disease (Monographella nivalis), eye spot disease (Pseudocercosporella herpotrichoides), leaf scorch disease (Septoria tritici), glume blotch disease (Leptosphaeria nodorum), Typhula snow blight disease (Typhula incarnata), Sclerotinia snow blight disease (Myriosclerotinia borealis), damping-off disease (Gaeumannomyces graminis), ergot disease (Claviceps purpurea), stinking smut disease (Tilletia caries), loose smut disease (Ustilago nuda), and the like.

Barley: leaf spot disease (Pyrenophora graminea), net blotch disease (Pyrenophora teres), leaf blotch disease (Rhynchosporium secalis), loose smut disease (Ustilago tritici, U. nuda), and the like.

Rice: blast disease (Pyricularia oryzae), sheath blight disease (Rhizoctonia solani), bakanae disease (Gibberella fujikuroi), brown spot disease (Cochliobolus miyabeanus), damping-off disease (Pythium graminicola), bacterial leaf blight (Xanthomonas oryzae), bacterial seedling blight disease (Burkholderia plantarii), brown stripe disease (Acidovorax avenae), bacterial grain rot disease (Burkholderia glumae), Cercospora leaf spot disease (Cercospora oryzae), false smut disease (Ustilaginoidea virens), rice brown spot disease (Alternaria alternata, Curvularia intermedia), kernel discoloration of rice (Alternaria padwickii), pink coloring of rice grains (Epicoccum purpurascens), and the like.

Tobacco: Sclerotinia rot disease (Sclerotinia sclerotiorum), powdery mildew disease (Erysiphe cichoracearum), Phytophthora rot disease (Phytophthora nicotianae), and the like.

Tulip: gray mold disease (Botrytis cinerea), and the like.

Sunflower: downy mildew disease (Plasmopara halstedii), Sclerotinia rot disease (Sclerotinia sclerotiorum), and the like.

Bent grass: Sclerotinia snow blight (Sclerotinia borealis), Large patch (Rhizoctonia solani), Brown patch (Rhizoctonia solani), Dollar spot (Sclerotinia homoeocarpa), blast disease (Pyricularia sp.), Pythium red blight disease (Pythium aphanidermatum), anthracnose disease (Colletotrichum graminicola), and the like.

Orchard grass: powdery mildew disease (Erysiphe graminis), and the like.

Soybean: purple stain disease (Cercospora kikuchii), downy mildew disease (Peronospora manshurica), Phytophthora rot disease (Phytophthora sojae), rust disease (Phakopsora pachyrhizi), Sclerotinia rot disease (Sclerotinia sclerotiorum), anthracnose disease (Colletotrichum truncatum), gray mold disease (Botrytis cinerea), Sphaceloma scab (Elsinoe glycines), melanoses (Diaporthe phaseolorum var. sojae), and the like.

Potato: hytophthora rot disease (Phytophthora infestans), early blight disease (Alternaria solani), scurf disease (Thanatephorus cucumeris), Verticillium wilt disease (Verticillium albo-atrum, V. dahlia, V. nigrescens, and the like.

Banana: Panama disease (Fusarium oxysporum), Sigatoka disease (Mycosphaerella fijiensis, M. musicola), and the like.

Rapeseed: Sclerotinia rot disease (Sclerotinia sclerotiorum), root rot disease (Phoma lingam), black leaf spot disease (Alternaria brassicae), and the like. Coffee: rust disease (Hemileia vastatrix), anthracnose (Colletotrichum coffeanum), leaf spot disease (Cercospora coffeicola), and the like.

Sugarcane: brown rust disease (Puccinia melanocephala), and the like.
Corn: zonate spot disease (Gloeocercospora sorghi), rust disease (Puccinia sorghi), southern rust disease (Puccinia polysora), smut disease (Ustilago maydis), brown spot disease (Cochliobolus heterostrophus), northern leaf blight (Setosphaeria turcica), and the like.

Cotton: seedling blight disease (Pythium sp.), rust disease (Phakopsora gossypii), sour rot disease (Mycosphaerella areola), anthracnose (Glomerella gossypii), and the like.

### V. Formulations

The present disclosure provides an enhancer compound and formulations thereof that enhance the potency of fungicides to effectively restrict the growth of pathogenic fungi affecting a crop, agricultural produce, seeds and/or soil. In certain non-limiting embodiments, the apyrase inhibitor can be provided at: from about 0.01 to about 80% weight to weight in a final composition, or from about 25% to about 55%, such as from about 30% to about 50%, from about 35% to about 45%, such as about 0.01, 0.05, 0.1, 0.5, 1.0, 1.1, 1.2, 1.3, 1.4, 1.5, 1.6, 1.7, 1.8, 1.9, 2.0, 2.5, 3.0, 4.0, 5.0, 7.5, 10, 20, 30, 40, 50, 55, 60 or 80% weight to weight in a final composition. In one embodiment the apyrase inhibitor is provided in liquid form at from about 0.01 to about 50%, such as from about 15% to about 50%, from about 20% to about 45%, from about 25% to about 40%, such as about 0.01, 0.05, 0.1, 0.5, 1.0, 1.1, 1.2, 1.3, 1.4, 1.5, 1.6, 1.7, 1.8, 1.9, 2.0, 2.5, 3.0, 4.0, 5.0, 7.5, 10, 15, 20, 30, 40 or 50% volume to volume in a final diluted composition. The skilled artisan will recognize that the formulation of the pesticide, the apyrase inhibitor or a combination thereof can be provided in a concentrate that can be diluted prior to use, or can be provided in a diluted form ready for treatment.

The enhancer, pesticide and combinations thereof are not particularly limited by the dosage form. Examples of the dosage form include wettable powders, emulsions, emulsifiable concentrates, oil-dispersible liquids, powders, granules, water-soluble agents, suspensions, granular wettable powders, and tablets. The method for preparing formulation is not particularly limited, and conventionally-known methods may be adopted depending on the dosage form.

Several formulation examples are described below. The preparation formulations shown below are merely examples, and may be modified within a range not contrary to the essence of the present disclosure. For example, additional active and inert components may be added to the formulations below. “Part” means “part by mass” unless otherwise specified.

### Formulation Example 1

### Wettable Powder

40 parts of the enhancer compound disclosed herein, 53 parts of diatomaceous earth, 4 parts of ethoxylated higher alcohol sulfate ester combined with a suitable solid carrier such as magnesium sulfate, and 3 parts of alkyl naphthalene sulfonate are mixed uniformly, and then finely pulverized to obtain wettable powders containing 40 parts by mass of the enhancer.

### Formulation Example 2

### Aqueous Suspension Concentrate

2.5 g of the enhancer compound are placed into a 100 mL glass beaker, together with 0.5 g of dispersant Tamol SN, 1 g of propylene glycol, 0.006 g (10 mM) boric acid powder buffer, 5 g of water, optionally 0.05 g low molecular weight surfactant Surfonic L24-7, and optionally 0.01 g of antifoam SAG 1572. 30 g of 2 mm diameter glass beads are added and a mechanical stirrer is used to mill the suspension to below 1.5 microns median diameter, as measured on a Malvern Mastersizer 3000. To the suspension concentrate are added 0.5 g of a pre-gel containing 2% xanthan polysaccharide and 2% biocide Acticide B20, and the mechanical stirrer is run for a further 10 minutes. The pH is adjusted to 9.0 using 2% phosphoric acid or 1M sodium hydroxide as needed. Water is added as needed to bring the final concentration to 25 wt % of compound B. The suspension concentrate is collected by sieving out the glass beads.

### Formulation Example 3

### Aqueous Suspension Concentrate

An aqueous suspension concentrate was prepared with the following composition: 30 wt % Compound 1, 2.5 wt % tristyrylphenol ethoxylate surfactant, 2.0 wt % ethyleneoxide-propyleneoxide block co-polymeric dispersant, 5.0 wt % propylene glycol freeze protectant, 0.1 30 wt % silicone oil antifoam, 52.4% distilled water, and after 2 hours of milling were added 8.0 wt % viscosity modifier gel comprising 2.0% xanthan and 1.0% biocide in water. Aliquots of this suspension were taken and adjusted to pH 8 with respectively 10 wt % sulfuric acid, pH10 borate buffer and 10 wt % sodium hydroxide.

### VI. Methods for Assessing Activity

The presently disclosed compounds exhibit activity against a variety of pathogens. Their activity is assessed in part according to the following assays:

### Method 1: In Vitro Apyrase Assay:

The apyrase inhibitory activity was assessed using an in vitro assay. The method of Windsor, Bio Techniques 33:1024-1030 (November 2002) was used as follows:

### Screen for Apyrase Inhibitors—

96 well plates were used for the assay: (Greiner bio-one: REF-655901- 96 well, PS, F-bottom, Clear, Non-binding)

### Buffers:

Reaction Buffer: 60 mM Hepes; 3 mM MgCl₂, 3 mM CaCl₂ and 3 mM ATP (pH 6.5)

Development Buffer A: 2% aqueous ammonium molybdate

Development Buffer B: 11% ascorbic acid in 37.5% TCA in water

Stop buffer C: 2% trisodium citrate in 2% acetic acid solution in water
Add 100 μl of reaction buffer to each well.
Add 10 μl of DMSO (control) or inhibitor/compound or compounds such as N1915 or orthovanadate to each well. (use inhibitor conc at 1 mM; orthovanadate at 2 mM and N1915 at 1 mM)
Add 10 μl of apyrase (concentration based on optimization—Dilute 1 U/μl enzyme to different concentrations such as 0.1 U, 0.05 U, 0.0025, 0.001 U, 0.0005 U—to find a good range)
Incubate plate at room temperature for 1 hr
Mix development buffer A and B in the ratio of 1:1.5 (just before use).
Add 50 ul of A:B mix in each well (incubate for 2 mins)
Add 50 ul of C in each well
Measure/Read Absorbance of plate @630 nm
   Compound 1 inhibited inhibited apyrase in this assay at about 60%. :

### Method 2: Greenhouse Crop Tests

In this method, Compound 1 was evaluated for ability to enhance the activity of one of four fungicides, Amistar (azoxystrobin), Imtrex (fluxapyroxad), Proline (prothioconazole) or Balaya (mefentrifluconazole and pyraclostrobin) against plant pathogenic fungi. Zymoseptoria tritici on wheat, Botrytis cinerea on tomatoes, Asian Soya Rust (Phakopsora pachyrhizi) on soybean, and Brown Rust (Puccinia recondita) on wheat, in a controlled greenhouse environment in combination with. In these studies, soybean cultivar Siverka, tomato (Money maker) and wheat plants (JB Diego) were used. Seeds were sown in 9 cm diameter pots to a depth of 1 to 2 cm using Petersfield potting compost (75% medium grade peat, 12% screened sterilized loam, 3% medium grade vermiculite, 10% grit (5 mm screened, lime free), 1.5 kg PG mix per m3, lime to pH5.5-6.0 and wetting agent (Vitax Ultrawet 200 ml per m3) and germinated/grown at 23° C. under a 16 h day/8 h night light regime. Plants were treated two to three weeks after sowing when they were at the BBCH 11 growth stage (first pair of true leaves (unifoliate) unfolded. A track sprayer was used to treat the plants with the mixture of commercial fungicide and test compound using a water volume of 200 L/ha. Plants were inoculated with the appropriate fungi (pathogen) 24 hours after treatment. Fungal pathogens used were Botrytis cinerea (Grey mold on tomato plants), Zymoseptoria tritici (Septoria leaf blotch on wheat plants), Puccinia triticina (Brown rust on wheat plants) and Phakopsora pachyrhyzi (Asian soy rust on soybean plants). Four replicates were used for each combination of fungicide, pathogen and test compound. Each plant was evaluated once the disease symptoms were fully expressed between seven to twenty days (depending on the pathogen) for % control of the disease. Appropriate controls were used for all experiments, including an ‘inoculation check’ wherein plants were inoculated with their specific pathogen to assess disease levels. Also, each commercial fungicide was tested on its own as a part of each treatment, this being benchmark against which the combination of Compound 1 with fungicide was evaluated. Exemplary combinations demonstrated enhanced disease control as compared to disease control observed with fungicide alone. That is, the present compounds, although not fungicidal by themselves, enhance the activity of fungicides.

In these studies the fungicide was applied at the following rates

| | Amistar | Imtrex | Proline | Balaya |
|---|---|---|---|---|
| Zymoseptoria tritici | 0.1 L/ha | 0.02 L/ha | 0.0075 L/ha | 0.0015 L/ha |
| Botrytis | 0.03 L/ha | 0.005 L/ha | 0.00075 L/ha | 0.0015 L/ha |
| Asian Soya Rust | 0.01 L/ha | 0.02 L/ha | 0.15 L/ha | 0.03 L/ha |
| Brown Rust | 0.03 L/ha | 0.35 L/ha | 0.125 L/ha | 0.2 L/ha |

Compound 1 was applied at either 15 ppm or 30 ppm.
At 15 ppm the results showed additional disease control benefit as set forth in the following table

| | Amistar | Imtrex | Proline | Balaya |
|---|---|---|---|---|
| Zymoseptoria tritici | — | 19.9% | 5.8% | — |
| Botrytis | 19.1%% | — | — | — |
| Asian Soya Rust | 11.4% | 6.3% | 98.0%% | 26.3% |
| Brown Rust | 11.6% | 65.4% | — | 86.4% |

At 30 ppm the results showed additional disease control benefit as set forth in the following table

| | Amistar | Imtrex | Proline | Balaya |
|---|---|---|---|---|
| Zymoseptoria tritici | 10.6% | —% | 15.0% | — |
| Botrytis | 35.8% | 10.6 | 12.4% | — |
| Asian Soya Rust | 13.0% | 19.7% | 96.0%% | 24.5% |
| Brown Rust | 36.5% | 82.4% | — | 87.0% |

In the tables above, the symbol “—” denotes that no results were obtained or that there was no observable activity. In some trials the lack of activity was due to application rate of the fungicide being too high for any activity to be observed over control. The results in the tables above demonstrate that Compound 1 exhibits significant synergy with Amistar, Imtrex and Proline against Z. tritici, Botrytis and Asian Soya Rust. Compound exhibits significant synergy in combination with Balaya against Asian Soya Rust and Brown Rust. Compound 1 exhibits significant synergy in combination with Amistar and Imtrex against Brown Rust.

### Method 3: Greenhouse Crop Test of Compound 1 with Metconazole

A 2019 field isolate of Zymoseptoria tritici (Septoria tritici) was grown on potato dextrose agar (PDA), amended with penicillin and streptomycin, to eliminate possible bacterial contamination, for 6 d at 20° C. This allows fungicide activity comparisons against a current strain of the pathogen, which will carry recent insensitivity (resistance) mutations.

Spore suspensions were made by flooding the plates with sterile distilled water and scraping gently. The spore suspensions were adjusted to 10⁶ conidia mL⁻¹, by haemocytometer counts and appropriate dilution, before final re-suspension in potato dextrose broth, amended with 1.5 g L⁻¹ gelatin and 0.5 g L⁻¹ sodium oleate.

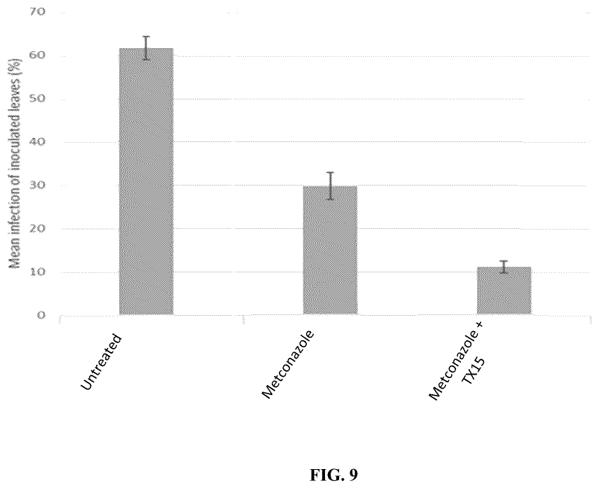

Septoria-susceptible winter wheat cv Trinity was planted in Levington M3 compost. Seeds (12-15 per pot) were planted per 9 cm pot and grown to growth stage 12. Plants were accommodated in a glasshouse with day heating to 20° C., venting at 22° C., and night heating to maintain 15° C. Plants were inoculated with Z. tritici by spraying spore suspensions at 10⁶ spores ml⁻¹ to just before run-off. Three replicate pots were used per treatment. The plants were placed in sealed, transparent propagators for 72 hours, to maintain high relative humidity and to ensure free water remained on leaves. Shading was provided to ensure the plants did not over-heat within the propagators. Preventative fungicide sprays were made 1 d before inoculation. Treatments were randomised within the glasshouse. All fungicides were applied at the equivalent rate of 200 L water per hectare, using a calibrated pressurised hand-held sprayer. This was achieved by placing plants to be treated in a 0.5 m² area and applying 10 mL of fungicide sprays. The results are illustrated in FIG. 9, which illustrates the synergistic effect of combining Compound 1 (indicated as TX15 in FIG. 9) with metconazole in the treatment of winter wheat infected with Z. tritici.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A method for inhibiting fungal infection in a seed or plant at risk thereof, comprising contacting the seed or plant with a fungicide comprising azoxystrobin, difenoconazole, chlorothalonil, tebuconazole, folpet, prothioconazole, fluxapyroxad, metconazole, mefentrifluconazole, pydiflumetofen, benzovindiflupyr, fenpicoxamid, cyazofamid, pyraclostrobin, or a combination thereof; and
the apyrase inhibitor (E)-3-methyl-N′-(1-(naphthalen-2-yl) ethylidene)benzohydrazide.

2. The method of claim 1, wherein the fungicide comprises metconazole.

3. The method of claim 1, wherein the fungicide comprises mefentrifluconazole.

4. The method of claim 1, wherein the fungicide comprises pydiflumetofen.

5. The method of claim 1, wherein the fungicide comprises benzovindiflupyr.

6. The method of claim 1, wherein the fungicide comprises fluxapyroxad.

7. The method of claim 4, further comprising contacting the seed or plant with azoxystrobin.

8. The method of claim 1, wherein the fungicide comprises prothioconazole.

9. The method of claim 1, wherein the fungicide comprises mefentrifluconazole.

10. The method of claim 1, wherein the fungicide comprises fenpicoxamid.

11. The method of claim 1, wherein the fungicide comprises difenoconazole.

12. The method of claim 11, wherein the fungicide further comprises azoxystrobin.

13. The method of claim 1, wherein the fungicide is selected from azoxystrobin, pyraclostrobin or a combination thereof.

14. The method of claim 1 wherein the fungicide comprises folpet.

15. The method of claim 1, wherein the fungicide comprises chlorothalonil

16. The method of claim 1, wherein the fungicide comprises pyraclostrobin.

17. The method of claim 1, wherein fungicide comprises cyazofamid.

18. A method for inhibiting fungal infection in a seed or plant at risk thereof, comprising contacting the seed or plant with azoxystrobin, difenoconazole, chlorothalonil, tebuconazole, folpet, prothioconazole, fluxapyroxad, metconazole, mefentrifluconazole, pydiflumetofen, benzovindiflupyr, fenpicoxamid, cyazofamid, pyraclostrobin,; and the apyrase inhibitor (E)-3-methyl-N′-(1-(naphthalen-2-yl) ethylidene) benzohydrazide, wherein the fungal infection comprises Asian Soybean Rust (Phakopsora pachyrhizi), Frogeye leaf spot (Cercospora sojina), Yellow Rust (Puccinia striiformis), downy mildew, or a combination thereof.

19. The method of claim 1, wherein the combination of the apyrase inhibitor and the fungicide have a synergistic effect on fungal infection.

20. A synergistically effective antifungal composition comprising a fungicide selected from the group consisting of fungicide comprising azoxystrobin, difenoconazole, chlorothalonil, tebuconazole, folpet, prothioconazole, fluxapyroxad, metconazole, mefentrifluconazole, pydiflumetofen, benzovindiflupyr, fenpicoxamid, cyazofamid, pyraclostrobin, or a combination thereof; and the apyrase inhibitor (E)-3-methyl-N′-(1-(naphthalen-2-yl) ethylidene) benzohydrazide.

21. The synergistically effective antifungal composition according to claim 20, wherein the fungicide comprises a compound selected from the group consisting of pydiflumetofen, benzovindiflupyr, fluxapyroxad, azoxystrobin, folpet, prothioconazole, mefentrifluconazole, fenpicoxamid, difenoconazole and combinations thereof.

22. The synergistically effective antifungal composition according to claim 20, wherein the fungicide comprises azoxystrobin.

23. The synergistically effective antifungal composition according to claim 20, wherein the composition is synergistically effective against Asian Soybean Rust Phakopsora pachyrhizi), Frogeye leaf spot (Cercospora sojina), Yellow Rust (Puccinia striiformis), downy mildew, or a combination thereof.

24. A method for inhibiting an infection of Z. tritici, Botrytis, Asian Soya Rust, Brown Rust, frog eye leaf spot, yellow rust, downy mildew or combination thereof in a seed or plant at risk thereof, comprising contacting the seed or plant with (E)-3-methyl-N′-(1-(naphthalen-2-yl) ethylidene) benzohydrazide; and a fungicide comprising azoxystrobin, fluxapyroxad, prothioconazole, mefentrifluconazole. pyraclostrobin folpet, pydiflumetofen, benzovindiflupyr, fenpicoxamid, cyazofamid, difenoconazole, metconazole or a combination thereof.

25. The method of claim 24 for inhibiting infection of Asian Soya Rust, Brown Rust, or both in a seed or plant at risk thereof, wherein the fungicide comprises mefentrifluconazole and pyraclostrobin.

26. The method of claim 24 for inhibiting infection of Brown Rust in a seed or plant at risk thereof, wherein the fungicide comprises azoxystrobin, fluxapyroxad, or both.

27. The method of claim 24 for inhibiting infection of Asian Soya Rust in a seed or plant at risk thereof, wherein the fungicide comprises azoxystrobin.

28. The method of claim 27 wherein the fungicide further comprises tebuconazole.

29. The method of claim 28, wherein the fungicide further comprises chlorothalonil.

30. The method of claim 24 for inhibiting infection of frogeye leaf spot in a seed or plant at risk thereof, wherein the fungicide comprises azoxystrobin.

31. The method of claim 30 wherein the fungicide further comprises tebuconazole.

32. The method of claim 30, wherein the fungicide further comprises chlorothalonil.

33. The method of claim 24 for inhibiting infection of yellow rust in a seed or plant at risk thereof, wherein the fungicide comprises azoxystrobin, folpet, prothioconazole, fluxapyroxad mefentrifluconazole, pydiflumetofen, benzovindiflupyr, fenpicoxamid, or a combination thereof.

34. The method of claim 33, wherein the fungicide comprises prothioconazole.

35. The method of claim 24 for inhibiting infection of Septoria in a seed or plant at risk thereof, wherein the fungicide comprises azoxystrobin, folpet, prothioconazole, fluxapyroxad mefentrifluconazole, pydiflumetofen, benzovindiflupyr, fenpicoxamid, or a combination thereof.

36. The method of claim 24 for inhibiting infection of downy mildew in a seed or plant at risk thereof, wherein the fungicide comprises cyazofamid.

37. The method of claim 24 for inhibiting infection of downy mildew in a seed or plant at risk thereof, wherein the fungicide comprises azoxystrobin, difenoconazole, or both.

36. The method of claim 24 inhibiting an infection of Z. tritici, wherein the fungicide comprises metconazole.
